(19) United States
(12) Patent Application Publication
(10) Pub. No.: US 2024/0304854 A1
(43) Pub. Date: Sep. 12, 2024

(54) UNIT SOLID-STATE BATTERY AND METHOD FOR PRODUCING UNIT SOLID-STATE BATTERY

(71) Applicant: HONDA MOTOR CO., LTD., Tokyo (JP)

(72) Inventors: Shigemitsu AKUTSU, Saitama (JP); Shinji FUJIMOTO, Saitama (JP); Toru SUKIGARA, Saitama (JP); Shintaro AOYAGI, Saitama (JP)

(21) Appl. No.: 18/546,783

(22) PCT Filed: Jan. 26, 2022
(86) PCT No.: PCT/JP2022/002811

§ 371 Date: Aug. 17, 2023

(30) Foreign Application Priority Data
Feb. 19, 2021 (JP) 2021-025327

(51) Int. Cl. H01M 10/0562; H01M 4/139; H01M 4/66

(52) U.S. Cl. CPC H01M 10/0562; H01M 4/139; H01M 4/661

(57) ABSTRACT

The present invention provides: unit solid-state batteries which have a single structure and are capable of constituting a solid-state battery module having an arbitrary capacity and an arbitrary output by being combined with each other without generating an ineffective portion of an electrode material in both ends of the stack; and a method for producing this unit solid-state battery. A unit solid-state battery which constitutes a solid-state battery, and which comprises: a solid electrolyte layer; and a negative electrode material layer and a positive electrode material layer, which are superposed on both surfaces of the solid electrolyte layer as electrode material layers. With respect to this unit solid-state battery, the negative electrode material layer and the positive electrode material layer do not contain a collector.

### TECHNICAL FIELD

The present invention relates to a unit solid-state battery and a method for producing a unit solid-state battery.

### BACKGROUND ART

Conventionally, lithium ion secondary batteries have been widely used as secondary batteries having high energy density. A lithium ion secondary battery has a structure in which a separator is present between a positive electrode and a negative electrode, and the battery is filled with a liquid electrolyte.

Since the electrolytic solution of such a lithium ion secondary battery is usually a combustible organic solvent, some lithium ion secondary batteries pose a safety issue of heat, in particular. Therefore, a solid-state battery employing an inorganic solid electrolyte as an alternative to the organic liquid electrolyte has been proposed. For example, a technique relating to a solid-state battery including an element part formed by laminating a first solid electrode layer, a solid electrolyte layer having lithium ion conductivity, and a second solid electrode layer in this order has been proposed (see Patent Document 1).
Patent Document 1: Japanese Unexamined Patent Application, Publication No. 2015-76178

### DISCLOSURE OF THE INVENTION

### Problems to be Solved by the Invention

In a case where a solid-state battery is constituted by cell units each including a solid electrode layer including a current collector as suggested in Patent Document 1, there is an issue that, when the cell units are laminated, the electrode material at each end of the laminate develops an ineffective region. Furthermore, since it is necessary to laminate a plurality of types of electrodes, there is an issue from the viewpoint of improvement in productivity.

In response to the above issues, an object of the present invention is to provide a unit solid-state battery capable of constituting a solid-state battery module having any capacity and output by a combination of the unit solid-state batteries having a single structure, without the electrode material at each end of the laminate developing an ineffective region, and a method for producing the same.

### Means for Solving the Problems

(1) A first aspect of the present invention relates to a unit solid-state battery constituting a solid-state battery. The unit solid-state battery includes a solid electrolyte layer, and a negative electrode material layer and a positive electrode material layer as electrode material layers respectively laminated on both sides of the solid electrolyte layer. The negative electrode material layer and the positive electrode material layer each do not include a current collector.

According to the first aspect of the present invention, it is possible to provide a unit solid-state battery capable of constituting a solid-state battery module having any capacity and output by a combination of the unit solid-state batteries having a single structure, without the current collecting electrodes at each end of the laminate developing an ineffective region.

(2) In a second aspect of the present invention according to the first aspect, in a plan view of the unit solid-state battery in a laminating direction, the solid electrolyte layer has a larger area than that of each of the negative electrode material layer and the positive electrode material layer. The solid electrolyte layer has an outer edge disposed outward of an outer edge of the negative electrode material layer and an outer edge of the positive electrode material layer.

According to the second aspect of the present invention, it is possible to provide a unit solid-state battery capable of preventing short circuit when laminated.

(3) A third aspect of the present invention relates to a solid-state battery module including a laminated cell structure formed by laminating a plurality of the unit solid-state batteries according to the first or second aspect. The laminated cell structure is a first laminated cell structure. In the first laminated structure, a current collecting electrode plate is disposed between each of the unit solid-state batteries. The unit solid-state batteries adjacent to each other are arranged such that the positive electrode material layers are adjacent to each other and the negative electrode material layers are adjacent to each other. A negative electrode plate serving as the current collecting electrode plate is disposed between the adjacent negative electrode material layers. A positive electrode plate serving as the current collecting electrode plate is disposed between the adjacent positive electrode material layers. The current collecting electrode plate or the electrode material layer disposed at one of two ends of the laminated cell structure of the laminated unit solid-state batteries is of the same type as the current collecting electrode plate or the electrode material layer disposed at the other of the two ends of the laminated cell structure of the laminated unit solid-state batteries.

According to the third aspect of the present invention, it is possible to provide a solid-state battery module having any capacity by a combination of unit solid-state batteries having a single structure, without the current collecting electrode at each end of the laminated cell structure developing an ineffective region.

(4) In a fourth aspect of the present invention according to the third aspect, the solid-state battery module is formed by laminating a plurality of the first laminated cell structures. A type of the current collecting electrode plate or the electrode material layer disposed at each of the two ends differs between the first laminated cell structures adjacent to each other.

According to the fourth aspect of the present invention, it is possible to provide a solid-state battery module having any capacity and output.

(5) A fifth aspect of the present invention relates to a solid-state battery module including a laminated cell structure formed by laminating a plurality of the unit solid-state batteries according to the first or second aspect. The laminated cell structure includes a second laminated cell structure. In the second laminated cell structure, a current collecting electrode plate is disposed between each of the unit solid-state batteries, the unit solid-state batteries adjacent to each other are arranged such that the negative electrode material layers are adjacent to each other and the positive electrode material layers are adjacent to each other. A negative electrode plate serving as the current collecting electrode plate is disposed between the adjacent negative electrode material layers. A positive electrode plate serving as the current collecting electrode plate is disposed between the adjacent positive electrode material layers. The current collecting electrode plate or the electrode material layer disposed at one of two ends of the laminated cell structure of the laminated unit solid-state batteries is of a different type to the current collecting electrode plate or the electrode material layer disposed at the other of the two ends of the laminated cell structure of the laminated unit solid-state batteries.

According to the fifth aspect of the present invention, it is possible to provide a solid-state battery module in which laminated structures each having any capacity can be connected in series.

(6) A sixth aspect A of the present invention relates to a solid-state battery module including a laminated cell structure formed by laminating a plurality of the unit solid-state batteries according to the first or second aspect. The laminated cell structure includes a third laminated cell structure. In the third laminated cell structure, a current collecting electrode plate is disposed between each of the unit solid-state batteries. The unit solid-state batteries adjacent to each other are arranged such that the negative electrode material layer and the positive electrode material layer are adjacent to each other. A bipolar electrode plate is disposed between the adjacent negative electrode material layer and the positive electrode material layer. The current collecting electrode plate or the electrode material layer disposed at one of two ends of the laminated cell structure of the laminated unit solid-state batteries is of a different type to the current collecting electrode plate or the electrode material layer disposed at the other of the two ends of the laminated cell structure of the laminated unit solid-state batteries. A negative electrode plate is disposed in contact with the negative electrode material layer and a positive electrode plate is disposed in contact with the positive electrode material layer, at the two ends of the laminated cell structure.

According to the sixth aspect of the present invention, unit solid-state batteries having a single structure can be connected in series, and a solid-state battery module having any capacity and output can be provided.

(7) A seventh aspect of the present invention relates to a method for producing a unit solid-state battery constituting a solid-state battery. The method includes a sheet forming step of forming a negative electrode material sheet including a negative electrode material, a positive electrode material sheet including a positive electrode material, and a solid electrolyte sheet including a solid electrolyte, and a pressing step of pressing the negative electrode material sheet and the positive electrode material sheet with the solid electrolyte sheet interposed therebetween.

According to the seventh aspect of the present invention, it is possible to produce a unit solid-state battery capable of constituting a solid-state battery module having any capacity and output by a combination of unit solid-state batteries having a single structure, without the current collecting electrode at each end of the laminated structure developing an ineffective region.

(8) An eighth aspect of the present invention relates to a method for producing a unit solid-state battery constituting a solid-state battery. The method includes a negative electrode material applying step of applying a negative electrode material layer including a negative electrode material to one side of a solid electrolyte sheet including a solid electrolyte, and a positive electrode material applying step of applying a positive electrode material layer including a positive electrode material to the other side of the solid electrolyte sheet.

According to the eighth aspect of the present invention, it is possible to produce a unit solid-state battery capable of constituting a solid-state battery module having any capacity and output by a combination of unit solid-state batteries having a single structure, without the current collecting electrode at each end of the laminated structure developing an ineffective region.

(9) In a ninth aspect of the present invention according to the seventh aspect, the method includes a first cutting step of cutting the negative electrode material sheet and the positive electrode material sheet, a second cutting step of cutting the solid electrolyte sheet so as to have a larger area than that of each of the positive electrode material sheet and the negative electrode material sheet in plan view, and a laminating step of laminating the negative electrode material sheet, the solid electrolyte sheet, and the positive electrode material sheet in this order.

According to the ninth aspect of the present invention, it is possible to produce a unit solid-state battery capable of preventing short circuit when laminated.

(10) A tenth aspect of the present invention relates to a method for producing a solid-state battery module formed by laminating a plurality of unit solid-state batteries produced by the method according to the ninth aspect. The method includes a disposing step of disposing a current collecting electrode plate between the unit solid-state batteries adjacent to each other between the laminating step and the pressing step.

According to the tenth aspect of the present invention, the production process of a solid-state battery module can be simplified.

### BRIEF DESCRIPTION OF THE DRAWINGS

FIG. 1 is a schematic sectional view showing a unit solid-state battery according to an embodiment of the present invention;

FIG. 2 is a schematic plan view of a unit solid-state battery according to an embodiment of the present invention viewed from a negative electrode material layer side;

FIG. 3 is a schematic plan view of a unit solid-state battery according to an embodiment of the present invention viewed from a positive electrode material layer side;

FIG. 4A is a schematic sectional view showing a first laminated structure according to an embodiment of the present invention;

FIG. 4B is a schematic sectional view showing a solid-state battery module including a first laminated structure according to an embodiment of the present invention;

FIG. 5A is a schematic sectional view showing a third laminated structure according to an embodiment of the present invention;

FIG. 5B is a schematic sectional view showing a solid-state battery module including a third laminated structure according to an embodiment of the present invention;

FIG. 6 is a schematic sectional view showing a solid-state battery module including a third laminated structure according to an embodiment of the present invention;

FIG. 7A is a schematic plan view of a solid-state battery module according to an embodiment of the present invention;

FIG. 7B is a schematic sectional view showing a solid-state battery module including a first laminated structure according to an embodiment of the present invention;

FIG. 8A is a schematic plan view of a solid-state battery module according to an embodiment of the present invention;

FIG. 8B is a schematic sectional view showing a solid-state battery module including a first laminated structure according to an embodiment of the present invention;

FIG. 9A is a schematic plan view of a solid-state battery module according to an embodiment of the present invention;

FIG. 9B is a schematic sectional view showing a solid-state battery module including a second laminated structure according to an embodiment of the present invention;

FIG. 9C is an exploded perspective view of a solid-state battery module according to an embodiment of the present invention;

FIG. 9D is a transparent perspective view showing a solid-state battery module according to an embodiment of the present invention;

FIG. 10A is a schematic plan view of a solid-state battery module according to an embodiment of the present invention;

FIG. 10B is a schematic sectional view showing a solid-state battery module including a third laminated structure according to an embodiment of the present invention;

FIG. 11A is a schematic plan view of a solid-state battery module according to an embodiment of the present invention;

FIG. 11B is a schematic sectional view showing a solid-state battery module including a third laminated structure according to an embodiment of the present invention;

FIG. 11C is an exploded perspective view of a solid-state battery module according to an embodiment of the present invention; and

FIG. 11D is a transparent perspective view showing a solid-state battery module according to an embodiment of the present invention.

### PREFERRED MODE FOR CARRYING OUT THE INVENTION

### <Unit Solid-State Battery>

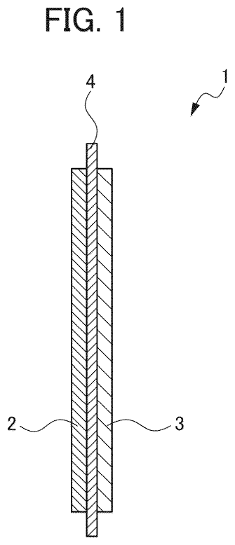

FIG. 1 is a schematic sectional view showing a unit solid-state battery 1 according to an embodiment of the present invention. The unit solid-state battery 1 according to the present embodiment is a unit of a solid-state battery constituting a solid-state battery module. As shown in FIG. 1, the unit solid-state battery 1 is formed by respectively disposing a negative electrode material layer 2 and a positive electrode material layer 3 on both sides of a solid electrolyte layer 4.

The negative electrode material layer 2 and the positive electrode material layer 3 each do not include a current collector such as a current collecting foil or a current collecting electrode plate. The negative electrode material layer 2 and the positive electrode material layer 3 may be separately produced in a sheet shape and integrated with the solid electrolyte layer 4 by pressing or the like, or may be formed in a layer shape by being respectively applied to both sides of the solid electrolyte layer 4. According to the above configuration, the unit solid-state battery 1 is formed integrally without including a current collector. This allows a solid-state battery module having any capacity and output to be formed by the combination of lamination of the unit solid-state batteries 1, and the current collecting electrode at each end of the laminate does not develop an ineffective region. Furthermore, since the negative electrode material layer 2 and the positive electrode material layer 3 each do not include a current collector such as a current collecting foil, the adhesion of the negative electrode material layer 2 and the positive electrode material layer 3 to the solid electrolyte layer 4 can be improved, and the input/output characteristics of the unit solid-state battery 1 can be improved.

### (Negative Electrode Material Layer)

The negative electrode material layer 2 includes a negative electrode active material as an essential component and does not include a current collector such as a current collecting foil or a current collecting electrode plate. The negative electrode material layer 2 may optionally include a conductivity aid, a binder, and the like, in addition to the negative electrode active material.

The negative electrode active material included in the negative electrode material layer 2 is not limited, and a known material capable of occluding and releasing charge transfer media such as lithium ions can be selected and used as appropriate. Examples of the negative electrode active material include lithium transition metal oxides such as lithium titanate, transition metal oxides such as TiO₂, Nb₂O₃, and WO₃, Si, SiO, metal sulfides, metal nitrides, carbon materials such as artificial graphite, natural graphite, graphite, soft carbon, and hard carbon, metallic lithium, metallic indium, and lithium alloys.

### (Positive Electrode Material Layer)

The positive electrode material layer 3 includes a positive electrode active material as an essential component and does not include a current collector such as a current collecting foil or a current collecting electrode plate. The positive electrode material layer 3 may optionally include a conductivity aid, a binder, and the like, in addition to the positive electrode active material.

The positive electrode active material included in the positive electrode material layer 3 is not limited, and a known material capable of occluding and releasing charge transfer media such as lithium ions can be selected and used as appropriate. Examples of the positive electrode active material include lithium cobaltate, lithium nickelate, lithium manganate, heterogeneous element-substituted Li—Mn spinel, lithium metal phosphate, lithium sulfide, and sulfur. Specific examples thereof include LiCoO₂, Li(Ni_{5/10}Co_{2/10}Mn_{3/10}) O₂, Li(Ni_{6/10}Co_{2/10}Mn_{2/10}) O₂, Li(Ni_{8/10}Co_{1/10}Mn_{1/10}) O₂, Li(Ni_{0.8}Co_{0.15}Al_{0.05}) O₂, Li(Ni_{1/6}Co_{4/6}Mn_{1/6}) O₂, Li(Ni_{1/3}Co_{1/3}Mn_{1/3}) O₂, LiCoO₄, LiMn₂O₄, LiNiO₂, and LiFePO₄.

The negative electrode material layer 2 and the positive electrode material layer 3 each may include other components other than the active material. The other components are not limited, and any components may be used as long as they can be used in producing a solid-state battery. For example, a conductivity aid, a binder, and the like can be used. Examples of the conductivity aid for the positive electrode include acetylene black. Examples of the binder for the positive electrode include polyvinylidene fluoride. Examples of the binder for the negative electrode include sodium carboxyl methyl cellulose, styrene-butadiene rubber, and sodium polyacrylate.

### (Solid Electrolyte Layer)

The solid electrolyte layer 4 includes at least a solid electrolyte material that is a solid or gel electrolyte. Charge transfer between the positive electrode active material and the negative electrode active material can be performed through the solid electrolyte material.

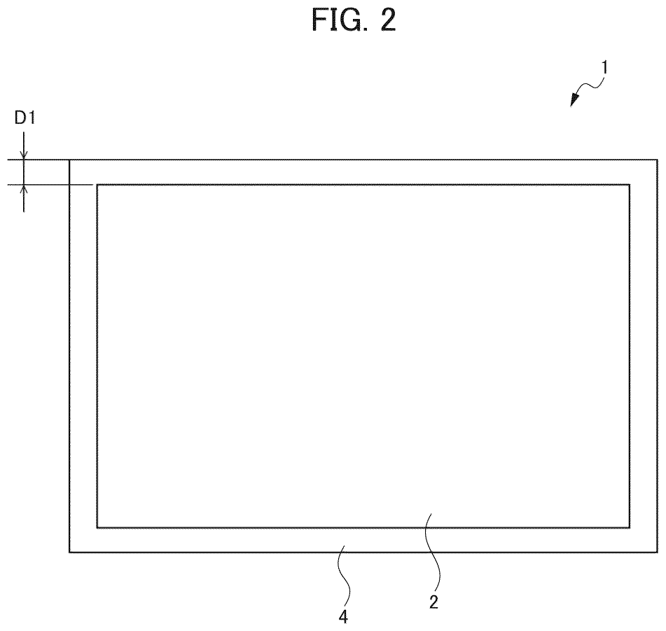

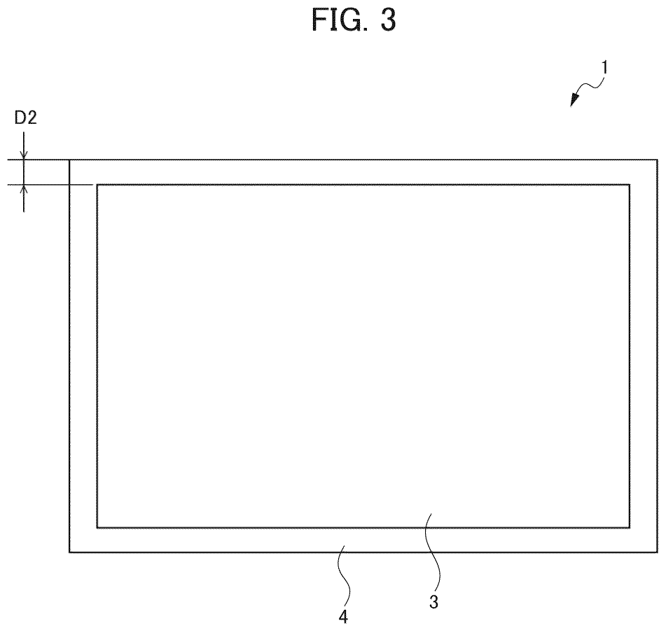

As shown in FIGS. 2 and 3, the solid electrolyte layer 4 has a larger area than that of each of the negative electrode material layer 2 and the positive electrode material layer 3 as viewed in a plan view in the laminating direction. FIG. 2 is a plan view from the side of the negative electrode material layer 2, and FIG. 3 is a plan view from the side of the positive electrode material layer 3. In addition to the above, the respective layers are arranged such that the outer edges of the solid electrolyte layer 4 encompass the outer edges of the negative electrode material layer 2 and the positive electrode material layer 3 as viewed in a plan view in the laminating direction. Specifically, as shown in FIG. 2, the outer edge of the solid electrolyte layer 4 is disposed further outward from the outer edge of the negative electrode material layer 2 by a length D1. Similarly, as shown in FIG. 3, the outer edge of the solid electrolyte layer 4 is disposed further outward from the outer edge of the positive electrode material layer 3 by a length D2. The length D1 may be equal to or greater than the thickness of the negative electrode material layer 2, and the length D2 may be equal to or greater than the thickness of the positive electrode material layer 3. The lengths D1 and D2 each may be 1 mm, for example. This can prevent short circuit when the unit solid-state batteries 1 are laminated.

The solid electrolyte material included in the solid electrolyte layer 4 is not limited. For example, a sulfide solid electrolyte material, an oxide solid electrolyte material, a nitride solid electrolyte material, a halide solid electrolyte material, or the like can be used.

### <Method for Producing Unit Solid-State Battery>

### [First Production Method]

It is preferable that the method for producing the unit solid-state battery 1 includes a sheet forming step of forming a negative electrode material sheet including a negative electrode material, a positive electrode material sheet including a positive electrode material, and a solid electrolyte sheet including a solid electrolyte, and a pressing step of pressing, with a press machine or the like, the negative electrode material sheet and the positive electrode material sheet with the solid electrolyte sheet interposed therebetween to integrate them.

Furthermore, it is preferable that the method includes, after the sheet forming step, a first cutting step of cutting the positive electrode material sheet and the negative electrode material sheet, a second cutting step of cutting the solid electrolyte sheet so as to have a larger area than that of each of the positive electrode material sheet and the negative electrode material sheet in plan view, and a laminating step of laminating the negative electrode material sheet, the solid electrolyte sheet, and the positive electrode material sheet in this order. In the laminating step, it is preferable to laminate them such that the outer edges of the negative electrode material sheet and the positive electrode material sheet do not protrude outward past the outer edges of the solid electrolyte sheet. This enables the production of the unit solid-state battery 1 that can prevent short circuit when laminated. In addition, adhesion between the solid electrolyte sheet and each of the negative electrode material sheet and the positive electrode sheet can be improved.

### [Second Production Method]

Instead of the first production method, the method for producing the unit solid-state battery 1 may include a negative electrode material applying step of applying a negative electrode material layer including a negative electrode material to one side of a solid electrolyte sheet including a solid electrolyte, and a positive electrode material applying step of applying a positive electrode material layer including a positive electrode material to the other side of the solid electrolyte sheet. In the negative electrode material applying step and the positive electrode material applying step, it is preferable to apply the negative electrode material layer and the positive electrode material layer such that the outer edges of the negative electrode material layer and the positive electrode material layer to be formed do not protrude outward past the outer edges of the solid electrolyte sheet. This enables the production of the unit solid-state battery 1 capable of preventing short circuit when laminated. In addition, adhesion between the solid electrolyte sheet and each of the negative electrode material layer and the positive electrode material layer can be improved.

The method of applying the negative electrode material and the positive electrode material in the negative electrode material applying step and the positive electrode material applying step is not limited. For example, it is possible to apply the negative electrode material including the negative electrode active material and the positive electrode material including the positive electrode active material on the solid electrolyte sheet by electrostatic application or other methods.

### <Solid-State Battery Module>

### [First Laminated Structure]

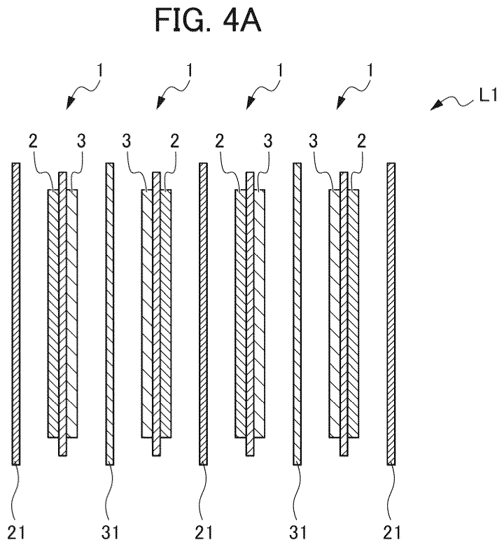

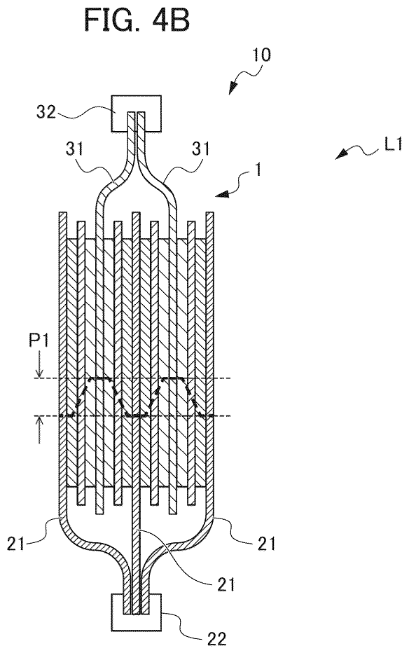

The configuration of a solid-state battery module 10 including a first laminated structure L1 will be described below with reference to FIGS. 4A and 4B. FIG. 4A is an explanatory diagram showing the first laminated structure Li of the solid-state battery module 10. As shown in FIG. 4A, the first laminated structure L1 is formed by laminating a plurality of unit solid-state batteries 1. The plurality of unit solid-state batteries 1 are arranged such that the negative electrode material layers 2 are adjacent to each other and the positive electrode material layers 3 are adjacent to each other. A negative electrode plate 21 is disposed between the adjacent negative electrode material layers 2. A positive electrode plate 31 is disposed between the adjacent positive electrode material layers 3. The number of the laminated unit solid-state batteries 1 is an even number. The current collecting electrode plates respectively arranged at the two ends of the laminated structure of the laminated unit solid-state batteries 1 are the negative electrode plates 21 that are the same type of electrode plates.

FIG. 4B shows the configuration of the solid-state battery module 10 including the first laminated structure Li. A plurality of negative electrode plates 21 in the solid-state battery module 10 are connected to a negative electrode terminal 22. Similarly, a plurality of positive electrode plates 31 are connected to a positive electrode terminal 32. Thus, four unit solid-state batteries 1 are connected in parallel. The dashed line in FIG. 4B is an image of the potential difference P1 of the solid-state battery module 10. Although not shown, the solid-state battery module 10 may include an exterior body made of a laminate film or the like in addition to the first laminated structure Li.

### (Negative Electrode Plate and Positive Electrode Plate)

The negative electrode plate 21 serving as a current collecting electrode plate is not limited, and is made of, for example, nickel, copper or a copper alloy, stainless steel, or the like. The positive electrode plate 31 serving as a current collecting electrode plate is not limited, and is made of, for example, aluminum, an aluminum alloy, stainless steel, nickel, iron, titanium, or the like. Examples of the shapes of the negative electrode plate 21 and the positive electrode plate 31 include a foil shape and a plate shape.

According to the solid-state battery module 10 including the first laminated structure Li, by laminating the unit solid-state batteries 1 having the same configuration such that electrode material layers of the same type are adjacent to each other, a solid-state battery module having any capacity can be formed. Furthermore, since the negative electrode plates 21 or the positive electrode plates 31 are disposed at both ends of the laminated structure, electrode materials are not disposed at both ends of the laminated structure, and the electrode material does not develop an ineffective region, as compared with a conventional solid-state battery in which electrode layers including current collectors and a solid electrolyte layer are laminated. Thereby, the energy density per module can be improved.

### [Second Laminated Structure]

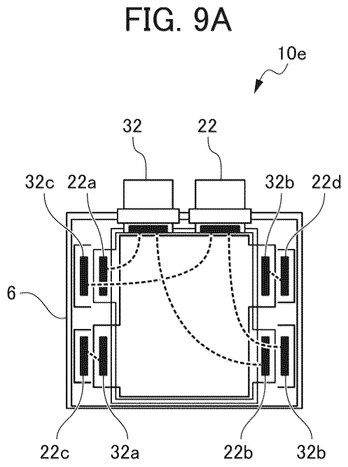

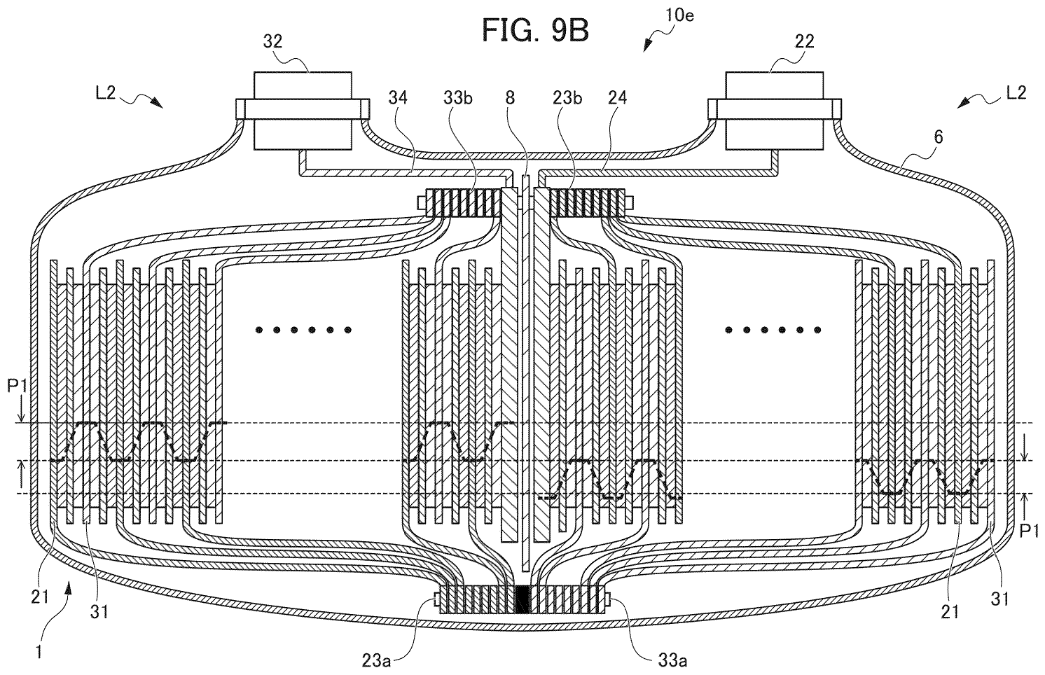

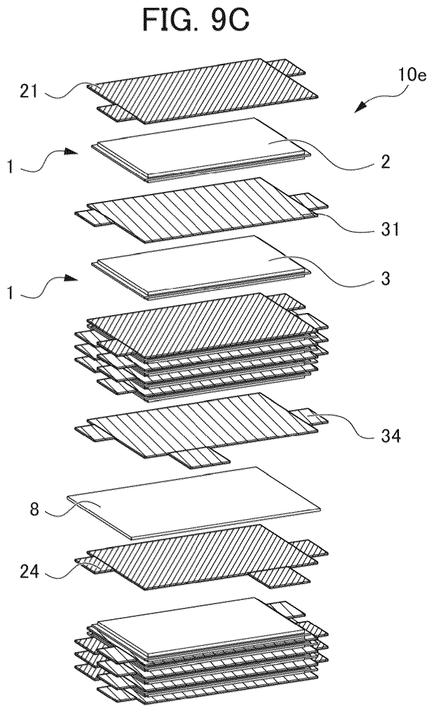

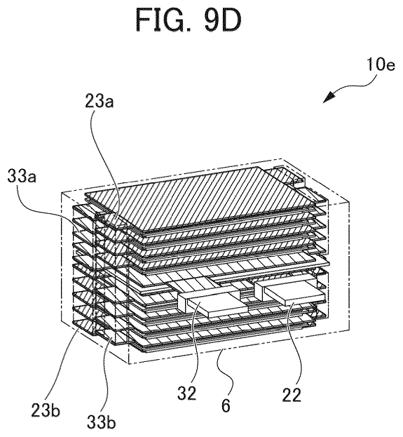

The configuration of a solid-state battery module 10e including a second laminated structure L2 will be described below with reference to FIG. 9B. Similarly to the first laminated structure Li, the second laminated structure L2 is arranged such that the negative electrode material layers 2 are adjacent to each other and the positive electrode material layers 3 are adjacent to each other. The differences between the second laminated structure L2 and the first laminated structure L1 are that in the second laminated structure L2, the number of laminated unit solid-state batteries 1 is an odd number, and the electrode material layer or the current collecting electrode plate disposed at one of the two ends of the laminated structure of the laminated unit solid-state batteries 1 is of a different type to the electrode material layer or the current collecting electrode plate disposed at the other of the two ends of the laminated structure of the laminated unit solid-state batteries 1. By combining a plurality of such second laminated structures L2, the second laminated structures L2 can be connected in series. Therefore, by adjusting the number of laminated unit solid-state batteries 1 constituting the second laminated structure L2 and the number of connections connecting the second laminated structures L2 in series, a solid-state battery module having any capacity and voltage can be formed. Other features of the solid-state battery module 10e will be described later in detail.

### [Third Laminated Structure]

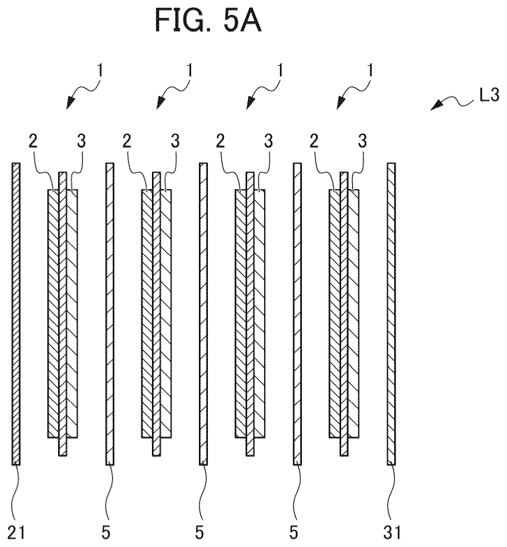

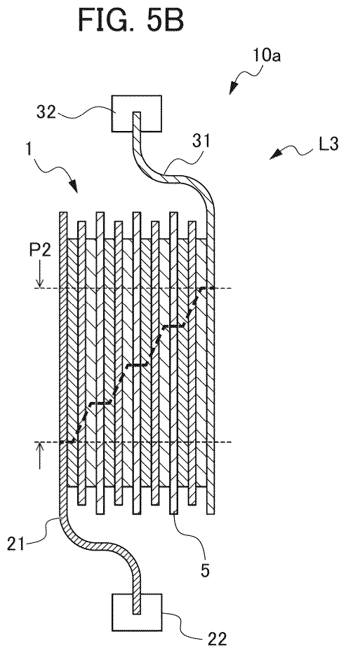

The configuration of a solid-state battery module 10a including a third laminated structure L3 will be described below with reference to FIGS. 5A and 5B. FIG. 5A is an explanatory diagram showing the third laminated structure L3 of the solid-state battery module 10a. As shown in FIG. 5A, the third laminated structure L3 is formed by laminating a plurality of unit solid-state batteries 1. The plurality of unit solid-state batteries 1 are arranged such that the negative electrode material layer 2 and the positive electrode material layer 3 are adjacent to each other. A bipolar electrode plate 5 is disposed between the adjacent negative electrode material layer 2 and positive electrode material layer 3. The current collecting electrode plates respectively arranged at the two ends of the laminated structure of the laminated unit solid-state batteries 1 are a negative electrode plate 21 and a positive electrode plate 31, which are different types of electrode plates.

FIG. 5B shows the configuration of the solid-state battery module 10a including the third laminated structure L3. The negative electrode plate 21 of the solid-state battery module 10a is connected to the negative electrode terminal 22. Similarly, the positive electrode plate 31 is connected to the positive electrode terminal 32. The bipolar electrode plate 5 is disposed between each of the plurality of unit solid-state batteries 1. Thus, four unit solid-state batteries 1 are connected in series. The dashed line in FIG. 5B is an image of the potential difference P2 of the solid-state battery module 10a.

### (Bipolar Electrode Plate)

The bipolar electrode plate 5 is, for example, an electrode in which a negative electrode material mixture layer serving as a negative electrode of a polarizable electrode is formed on one side of one sheet-shaped current collector (current collecting foil) and a positive electrode mixture layer serving as a positive electrode of the polarizable electrode is formed on the other side. The sheet-shaped current collector is not limited, and examples thereof include a stainless steel foil.

According to the solid-state battery module 10a including the third laminated structure L3, by laminating the unit solid-state batteries 1 having the same configuration such that different types of electrode material layers are adjacent to each other, a solid-state battery module having any voltage can be formed. Furthermore, as in the case of the solid-state battery module including the first laminated structure Li, the electrode material at each end of the laminated structure does not develop an ineffective region, and the energy density per module can be improved.

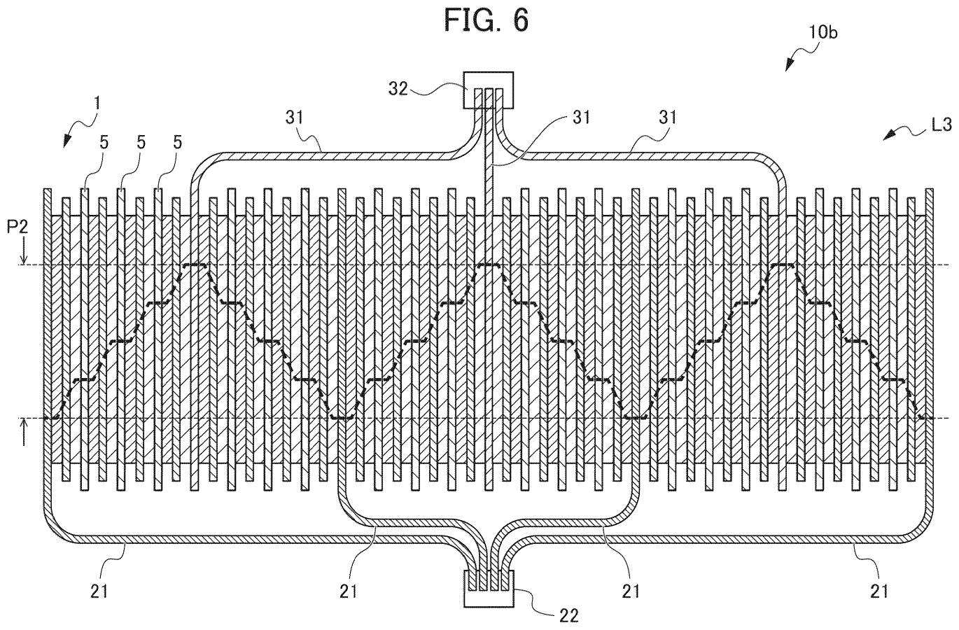

Alternatively, the third laminated structures L3 can be connected in parallel. FIG. 6 shows the configuration of a solid-state battery module 10b in which six third laminated structures L3 having a potential difference P2 are connected in parallel. Adjacent electrode material layers arranged at ends of adjacent third laminated structures L3 are of the same type. The negative electrode plate 21 or the positive electrode plate 31 disposed between the adjacent electrode material layers of the same type is a common current collecting electrode plate. A plurality of negative electrode plates 21 are connected to a common negative electrode terminal 22. A plurality of positive electrode plates 31 are connected to a common positive electrode terminal 32. Thereby, the plurality of third laminated structures L3 can be connected in parallel. Accordingly, by adjusting the number of the third laminated structures L3 connected in parallel, a solid-state battery module having any capacity can be formed.

### First Embodiment

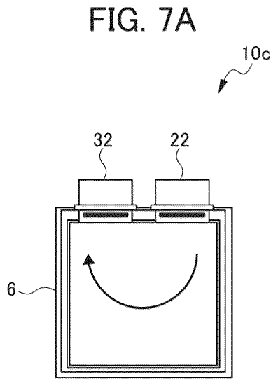

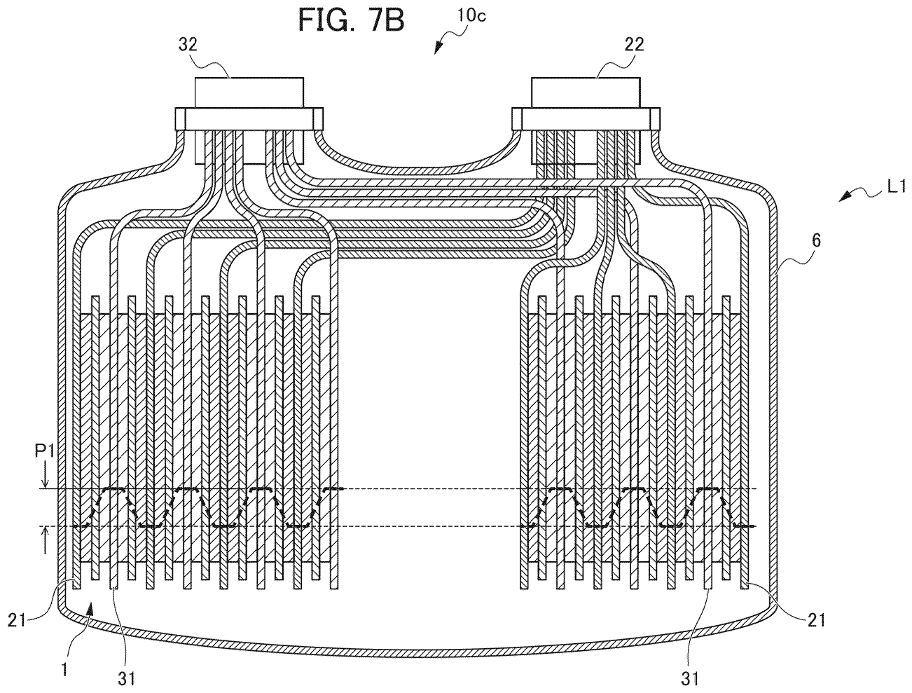

Next, the configuration of a solid-state battery module according to a preferred embodiment of the present invention will be described. As shown in FIG. 7B, a solid-state battery module 10c according to the present embodiment includes a first laminated structure Li. The first laminated structure Li is housed in an exterior body 6.

### (Exterior Body)

The exterior body 6 is an exterior body of the solid-state battery module 10c, and houses the first laminated structure Li therein. The exterior body 6 is, but not limited to, a laminate cell, for example. The laminate cell has a multilayer structure in which a heat-sealable resin layer made of polyolefin or the like is laminated on the outer side of a metal layer made of aluminum, stainless steel (SUS), or the like. In addition to the above, the laminate cell may include a layer made of polyamide such as nylon, polyester such as polyethylene terephthalate, or the like, and an adhesive layer made of any laminate adhesive, or the like. The exterior body 6 is not limited to a laminate cell, and may be, for example, a metal can.

As shown in FIG. 7A, in the solid-state battery module 10c, a negative electrode terminal 22 and a positive electrode terminal 32 are arranged on the same side surface of the solid-state battery module 10c. Accordingly, as schematically shown by an arrow in FIG. 7A, current flows from the negative electrode terminal 22 to the positive electrode terminal 32. Thereby, the extending directions of the negative electrode terminal 22 and the positive electrode terminal 32 can be made the same direction. Therefore, the layout of the solid-state battery module 10c can be improved.

Hereinafter, other embodiments of the present invention will be described. Descriptions of the same components as those described above may be omitted.

### Second Embodiment

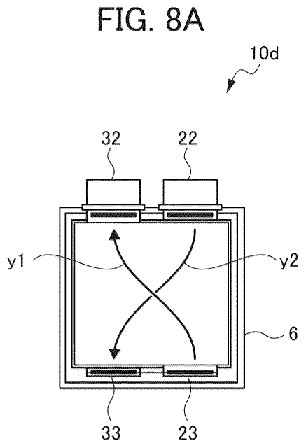

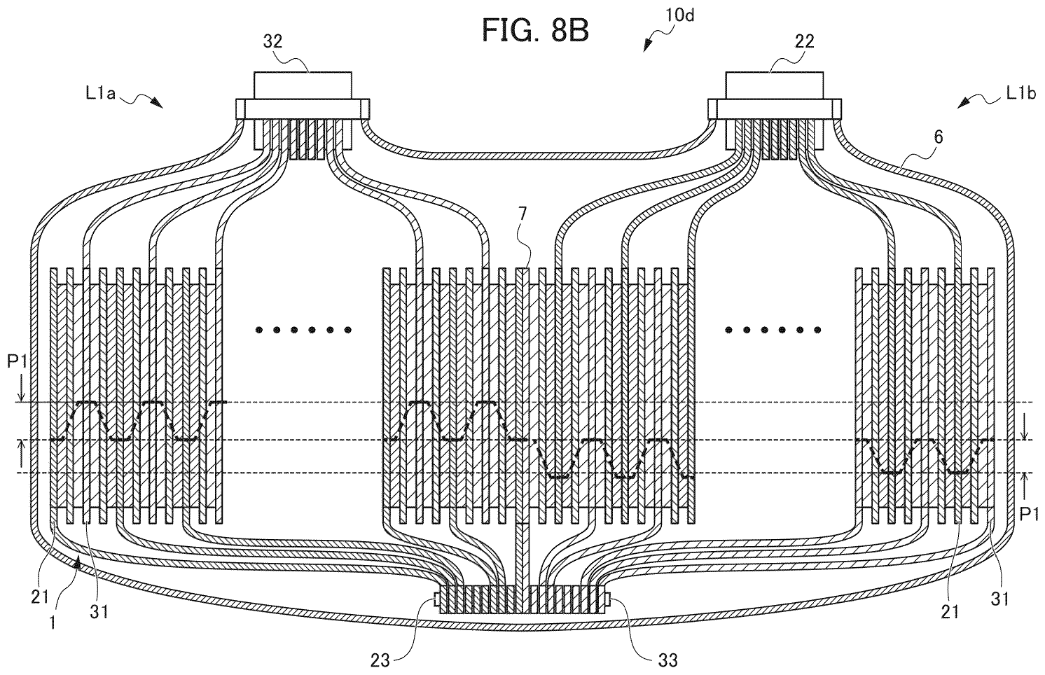

As shown in FIG. 8B, a solid-state battery module 10d according to the present embodiment is formed by laminating a first laminated structure L1a and a first laminated structure L1b. In the first laminated structure L1a, a negative electrode plate 21 is disposed at an outer end of the laminated structure, and a negative electrode material layer 2 is disposed at an inner end of the laminated structure adjacent to the first laminated structure L1b. In the first laminated structure L1b, a positive electrode plate 31 is disposed at an outer end of the laminated structure, and a positive electrode material layer 3 is disposed at an inner end of the laminated structure adjacent to the first laminated structure L1a. The adjacent negative electrode material layer 2 of the first laminated structure L1a and the positive electrode material layer 3 of the first laminated structure L1b are connected by a clad electrode 7. The clad electrode 7 has a clad structure in which, for example, different metals such as copper or a copper alloy and aluminum or an aluminum alloy are superposed by a method such as ultrasonic welding or vibration welding. The clad electrode 7 can electrically connect the negative electrode and the positive electrode that include different metals.

In the first laminated structure L1a, a plurality of negative electrode plates 21 are connected to a negative electrode terminal 22, and a plurality of positive electrode plates 31 are connected to a positive electrode terminal 33. In the first laminated structure L1b, a plurality of negative electrode plates 21 are connected to a negative electrode terminal 23, and a plurality of positive electrode plates 31 are connected to a positive electrode terminal 32. The negative electrode terminal 23 and the positive electrode terminal 33 are arranged inside an exterior body 6. As shown in FIG. 8A, the negative electrode terminal 22 and the positive electrode terminal 33 are arranged on opposite side surfaces, and the negative electrode terminal 23 and the positive electrode terminal 32 are arranged on opposite side surfaces, of the solid-state battery module 10d in plan view. Accordingly, as indicated by an arrow y1 in FIG. 8A, current flows from the negative electrode terminal 23 to the positive electrode terminal 32. Similarly, as indicated by an arrow y2, current flows from the negative electrode terminal 22 to the positive electrode terminal 33. The above arrangement of the negative electrode terminals and positive electrode terminals ensures uniform transmission of the charge transfer medium on the electrode plates. Therefore, the internal resistance is reduced, and the output of the solid-state battery module 10d can be improved.

As shown in FIG. 8B, the solid-state battery module 10d has the same potential at both ends of the laminate. Therefore, it is not necessary to dispose a short-circuit preventing member such as an insulating member between the first laminated structure L1a/the first laminated structure L1b and the exterior body 6.

### Third Embodiment

As shown in FIG. 9B, a solid-state battery module 10e according to the present embodiment includes second laminated structures L2. In the second laminated structure L2 disposed on the left side in FIG. 9B, a negative electrode plate 21 is disposed at an outer end of the laminated structure, and a positive electrode material layer 3 and a positive electrode current collecting electrode plate 34 are disposed at an inner end of the laminated structure. In the second laminated structure L2 disposed on the right side in FIG. 9B, a positive electrode plate 31 is disposed at an outer end of the laminated structure, and a negative electrode material layer 2 and a negative electrode current collecting electrode plate 24 are disposed at an inner end of the laminated structure. An insulating member 8 is disposed between the two second laminated structures L2. The solid-state battery module 10e includes a plurality of negative electrode terminals 22a, 22b, 22c, and 22d and a plurality of positive electrode terminals 32a, 32b, 32c, and 32d. The negative electrode plate 21 and the positive electrode plate 31 of the second laminated structures L2 are respectively connected to the positive electrode terminals and the negative electrode terminals. Thereby, as schematically shown by dashed lines in FIG. 9A, current flows on each electrode plate. Since the solid-state battery module 10e includes the plurality of positive electrode terminals and negative electrode terminals, the charge transfer medium is uniformly transmitted on the electrode plates. Therefore, the internal resistance is reduced, and the output of the solid-state battery module 10e can be improved.

FIG. 9C is an exploded perspective view of the solid-state battery module 10e. The negative electrode current collecting plate 24 is made of, for example, a metal plate made of the same material as the negative electrode plate 21, and is made of, for example, copper or a copper alloy. The negative electrode current collecting electrode plate 24 is electrically connected to a plurality of negative electrode terminals. Alternatively, a part of the negative electrode current collecting plate 24 may be used as a negative electrode terminal. The positive electrode current collecting electrode plate 34 is made of, for example, a metal plate made of the same material as the positive electrode plate 31, and is made of, for example, aluminum or an aluminum alloy. The positive electrode current collecting plate 34 is electrically connected to a plurality of positive electrode terminals. Alternatively, a part of the positive electrode current collecting plate 34 may be used as a positive electrode terminal. As shown in FIGS. 9B and 9D, a negative electrode terminal 23a, to which a plurality of negative electrode plates are connected, and a positive electrode terminal 33a are electrically connected to each other inside an exterior body 6. Thereby, the plurality of second laminated structures L2 can be connected in series inside the cell. For the connection, for example, a clad material having a clad structure in which different metals are superposed can be used. The same feature as that of the clad electrode 7 can apply to the clad material.

### Fourth Embodiment

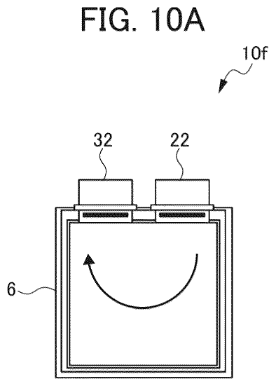

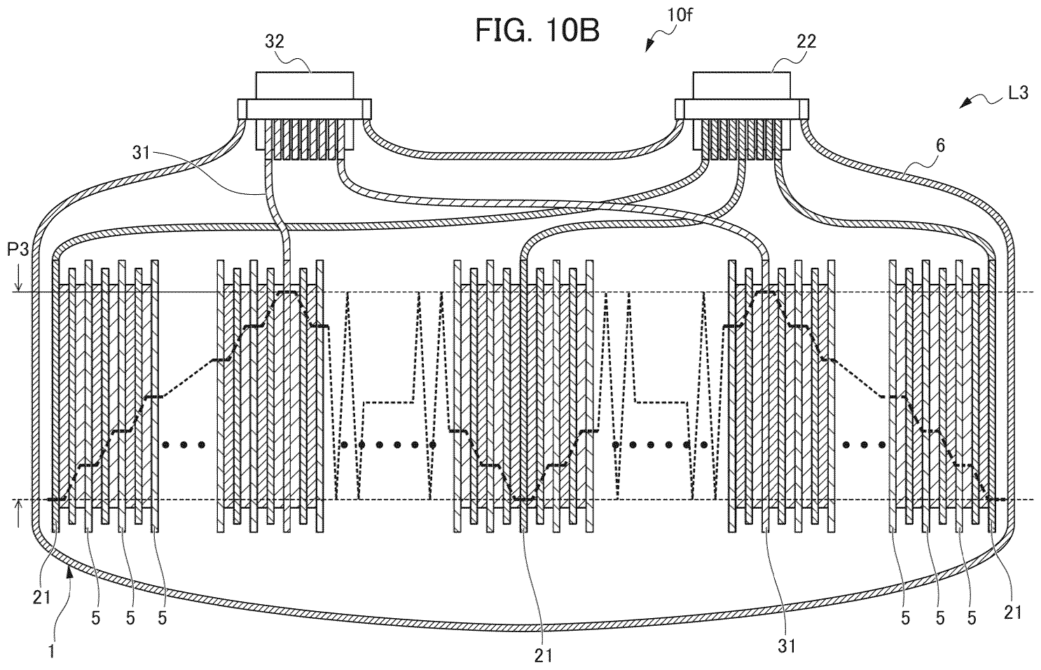

As shown in FIG. 10B, a solid-state battery module 10f according to the present embodiment includes third laminated structures L3. In the present embodiment, four third laminated structures L3 are connected in parallel. The number of the laminated structures connected in parallel may be any number. A negative electrode plate 21 or a positive electrode plate 31, which is a common current collecting electrode plate, is disposed between each of the third laminated structures L3. The number of unit solid-state batteries 1 constituting each of the third laminated structures L3 may be any number corresponding to a desired potential difference P3. Thus, by laminating the unit solid-state batteries 1 having the same structure, the solid-state battery module 10f having any capacity and voltage can be formed.

### Fifth Embodiment

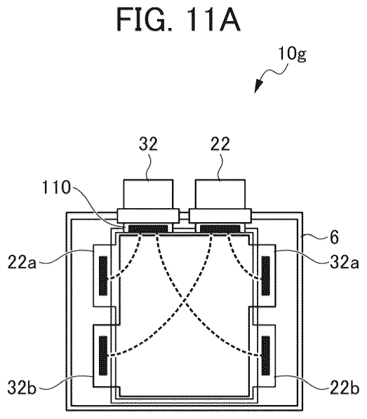

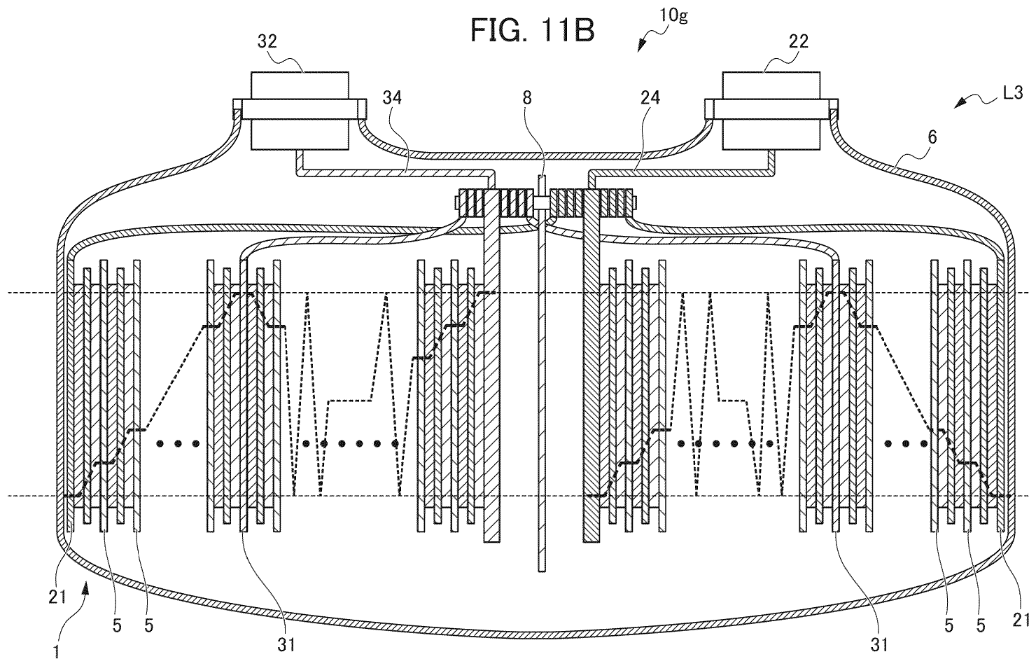

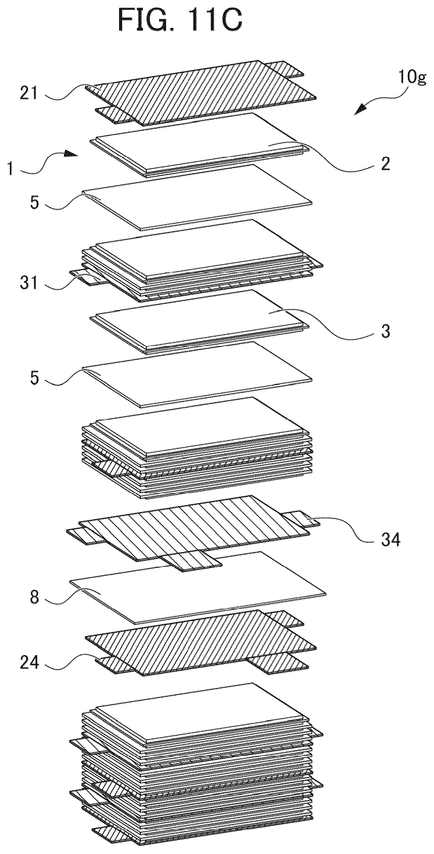

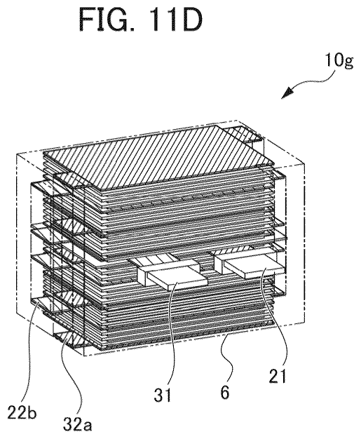

As shown in FIG. 11B, a solid-state battery module 10g according to the present embodiment includes third laminated structures L3. Adjacent third laminated structures L3 are laminated such that electrode material layers of the same type are adjacent to each other. The number of the third laminated structures L3 laminated may be any number. A negative electrode plate 21 and a positive electrode plate 31 of the third laminated structure L3 are respectively electrically connected to a plurality of negative electrode terminals 22a and 22b and positive electrode terminals 32a and 32b inside an exterior body 6. Thereby, as schematically shown by dashed lines in FIG. 11A, current flows on each electrode plate. Since the solid-state battery module 10g includes the plurality of positive electrode terminals and negative electrode terminals, the charge transfer medium is uniformly transmitted on the electrode plates. Therefore, the internal resistance is reduced, and the output of the solid-state battery module 10g can be improved.

FIG. 11C is an exploded perspective view of the solid-state battery module 10g. The solid-state battery module 10g includes a negative electrode current collecting plate 24 and a positive electrode current collecting plate 34 each having the same features as in the third embodiment. In the present embodiment, a plurality of the negative electrode plates 21 and the negative electrode current collecting electrode plate 24 are electrically connected to each other at the negative electrode terminal 22b inside the exterior body 6 as shown in FIG. 11D. Similarly, a plurality of positive electrode plates 31 and the positive electrode current collecting plate 34 are electrically connected to each other at the positive electrode terminal 32a. The negative electrode terminal 22b and the positive electrode terminal 32a may be respectively part of the negative electrode current collecting electrode plate 24 and part of the positive electrode current collecting electrode plate 34. According to the above configuration, series or parallel connection can be achieved inside the cell, and the solid-state battery module 10g having any capacity and voltage can be formed.

### <Method for Producing Solid-State Battery Module>

The method for producing a solid-state battery module according to the present embodiment includes a disposing step of disposing a predetermined current collecting electrode plate between each of unit solid-state batteries 1, and a pressing step of pressing and integrating the unit solid-state batteries 1 and the current collecting electrode plate by a press machine or the like in a state where the unit solid-state batteries 1 and the current collecting electrode plate are laminated.

In a case where the method for producing the unit solid-state battery 1 includes a pressing step of laminating a negative electrode material sheet, a solid electrolyte sheet, and a positive electrode material sheet in this order and pressing them, a disposing step of disposing the predetermined current collecting electrode plate between each of the unit solid-state batteries 1 may be provided before pressing. This allows the solid-state battery modules to be produced without the pressing step for integrating the unit solid-state batteries 1.

The pressing step in producing the unit solid-state battery 1 and the pressing step in producing the solid-state battery module may be separate steps. This can improve adhesion between the solid electrolyte sheet and each of the negative electrode material sheet and the positive electrode material sheet in the unit solid-state battery 1.

Although preferred embodiments of the present invention have been described above, the present invention is not limited to the above-described embodiments. Modifications as appropriate are also included in the scope of the present invention.

### EXPLANATION OF REFERENCE NUMERALS

1 unit solid-state battery
2 negative electrode material layer
3 positive electrode material layer
4 solid electrolyte layer
10, 10a, 10b, 10c, 10d, 10e, 10f, 10g solid-state battery module
21 negative electrode plate
31 positive electrode plate
5 bipolar electrode plate
L1 first laminated cell structure
L2 second laminated cell structure
L3 third laminated cell structure

1. A unit solid-state battery constituting a solid-state battery, the unit solid-state battery comprising:
a solid electrolyte layer; and
a negative electrode material layer and a positive electrode material layer as electrode material layers respectively laminated on both sides of the solid electrolyte layer,
the negative electrode material layer and the positive electrode material layer each not comprising a current collector.

2. The unit solid-state battery according to claim 1, wherein, in a plan view of the unit solid-state battery in a laminating direction,
the solid electrolyte layer has a larger area than that of each of the negative electrode material layer and the positive electrode material layer, and
the solid electrolyte layer has an outer edge disposed outward of an outer edge of the negative electrode material layer and an outer edge of the positive electrode material layer.

3. A solid-state battery module comprising a laminated cell structure formed by laminating a plurality of the unit solid-state batteries according to claim 1,
the laminated cell structure being a first laminated cell structure, wherein
a current collecting electrode plate is disposed between each of the unit solid-state batteries,
the unit solid-state batteries adjacent to each other are arranged such that the positive electrode material layers are adjacent to each other and the negative electrode material layers are adjacent to each other,
a negative electrode plate serving as the current collecting electrode plate is disposed between the adjacent negative electrode material layers,
a positive electrode plate serving as the current collecting electrode plate is disposed between the adjacent positive electrode material layers, and
the current collecting electrode plate or the electrode material layer disposed at one of two ends of the laminated cell structure of the laminated unit solid-state batteries is of the same type as the current collecting electrode plate or the electrode material layer disposed at the other of the two ends of the laminated cell structure of the laminated unit solid-state batteries.

4. The solid-state battery module according to claim 3, wherein
the solid-state battery module is formed by laminating a plurality of the first laminated cell structures, and
a type of the current collecting electrode plate or the electrode material layer disposed at each of the two ends differs between the first laminated cell structures adjacent to each other.

5. A solid-state battery module comprising a laminated cell structure formed by laminating a plurality of the unit solid-state batteries according to claim 1,
the laminated cell structure being a second laminated cell structure, wherein
a current collecting electrode plate is disposed between each of the unit solid-state batteries,
the unit solid-state batteries adjacent to each other are arranged such that the negative electrode material layers are adjacent to each other and the positive electrode material layers are adjacent to each other,
a negative electrode plate serving as the current collecting electrode plate is disposed between the adjacent negative electrode material layers,
a positive electrode plate serving as the current collecting electrode plate is disposed between the adjacent positive electrode material layers, and
the current collecting electrode plate or the electrode material layer disposed at one of two ends of the laminated cell structure of the laminated unit solid-state batteries is of a different type to the current collecting electrode plate or the electrode material layer disposed at the other of the two ends of the laminated cell structure of the laminated unit solid-state batteries.

6. A solid-state battery module comprising a laminated cell structure formed by laminating a plurality of the unit solid-state batteries according to claim 1,
the laminated cell structure being a third laminated cell structure, wherein
a current collecting electrode plate is disposed between each of the unit solid-state batteries,
the unit solid-state batteries adjacent to each other are arranged such that the negative electrode material layer and the positive electrode material layer are adjacent to each other,
a bipolar electrode plate is disposed between the adjacent negative electrode material layer and the positive electrode material layer,
the current collecting electrode plate or the electrode material layer disposed at one of two ends of the laminated cell structure of the laminated unit solid-state batteries is of a different type to the current collecting electrode plate or the electrode material layer disposed at the other of the two ends of the laminated cell structure of the laminated unit solid-state batteries, and
a negative electrode plate is disposed in contact with the negative electrode material layer and a positive electrode plate is disposed in contact with the positive electrode material layer, at the two ends of the laminated cell structure.

7. A method for producing a unit solid-state battery constituting a solid-state battery, the method comprising:
a sheet forming step of forming a negative electrode material sheet comprising a negative electrode material, a positive electrode material sheet comprising a positive electrode material, and a solid electrolyte sheet comprising a solid electrolyte; and
a pressing step of pressing the negative electrode material sheet and the positive electrode material sheet with the solid electrolyte sheet interposed therebetween.

8. A method for producing a unit solid-state battery constituting a solid-state battery, the method comprising:
a negative electrode material applying step of applying a negative electrode material layer comprising a negative electrode material to one side of a solid electrolyte sheet comprising a solid electrolyte; and
a positive electrode material applying step of applying a positive electrode material layer comprising a positive electrode material to the other side of the solid electrolyte sheet.

9. The method according to claim 7, comprising:
a first cutting step of cutting the negative electrode material sheet and the positive electrode material sheet;
a second cutting step of cutting the solid electrolyte sheet so as to have a larger area than that of each of the positive electrode material sheet and the negative electrode material sheet in plan view; and
a laminating step of laminating the negative electrode material sheet, the solid electrolyte sheet, and the positive electrode material sheet in this order.

10. A method for producing a solid-state battery module formed by laminating a plurality of unit solid-state batteries produced by the method according to claim 9, the method comprising:
a disposing step of disposing a current collecting electrode plate between each of the unit solid-state batteries adjacent to each other between the laminating step and the pressing step.
